(19) United States
(12) Patent Application Publication
(10) Pub. No.: US 2004/0080403 A1
(43) Pub. Date: Apr. 29, 2004

(54) Lock status indicator

(76) Inventor: Meir Eshel, Haifa (IL)

Correspondence Address: Dekel Patent Ltd., Beit HaRof'im, Room 27, 18 Menuha VeNahala Street, Rehovot, IL

(21) Appl. No.: 10/289,262

(22) Filed: Nov. 7, 2002

(30) Foreign Application Priority Data
Oct. 27, 2002 (IL) 152505

(51) Int. Cl. B60Q 1/00

(52) U.S. Cl. 340/425.5; 340/426.15

(57) ABSTRACT

Apparatus comprising a key ring fob comprising a lock status indicator able to indicate if a lock is locked or unlocked. The lock status indicator may indicate if the last action performed on the lock was a locking or an unlocking action. A time indicating device may indicate when the last action performed on the lock was performed

### FIELD OF THE INVENTION

The present invention relates generally to apparatus for providing an indication if a lock is in a locked or unlocked state, particularly useful for electronically lockable locks, such as vehicle door locks.

### BACKGROUND OF THE INVENTION

Doors with electronically lockable locks are well known and prevalent. Automobile door locks, for example, may be locked or unlocked by pressing on an appropriate button of a key ring fob remote control.

Unfortunately, it may often occur that the user does not remember whether he/she locked the door. This may cause anxiety and panic to rush back to the vehicle to check whether the door was indeed locked or not.

### SUMMARY OF THE INVENTION

The present invention seeks to provide an improved apparatus for providing an indication if a lock is in a locked or unlocked state, particularly useful for electronically lockable locks, such as vehicle door locks. The apparatus may comprise a key ring fob remote control, as is described more in detail hereinbelow.

There is thus provided in accordance with an embodiment of the present invention apparatus comprising a key ring fob comprising a lock status indicator able to indicate if a lock is locked or unlocked.

In accordance with an embodiment of the present invention the lock status indicator is able to indicate if the last action performed on the lock was a locking or an unlocking action.

Further in accordance with an embodiment of the present invention the lock status indicator comprises a time indicating device able to indicate when the last action performed on the lock was performed. The time indicating device may comprise a time indication of the current time, an alarm clock, a timer and/or an elapsed time display, for example.

In accordance with an embodiment of the present invention the lock status indicator comprises a visual indicator. The visual indicator may comprise a light with an illumination code and/or an alphanumeric display.

Further in accordance with an embodiment of the present invention the lock status indicator may comprise an audible indicator.

In accordance with an embodiment of the present invention the key ring fob further comprises a remote control to lock or unlock a lock.

Further in accordance with an embodiment of the present invention the lock status indicator comprises a remote control to lock or unlock a lock, the remote control comprising a two-state switch that is movable between a first position that generates a signal to lock the lock and a second position that generates a signal to unlock the lock, the first position comprising character markings that indicate a locked status of the lock and the second position comprising character markings that indicate an unlocked status of the lock.

There is also provided in accordance with an embodiment of the present invention a method for indicating lock status, comprising providing a lock status indicator, able to indicate if a lock is locked or unlocked, on a key ring fob.

There is also provided in accordance with an embodiment of the present invention a system comprising a lock, and a key ring fob comprising a lock status indicator communicable with the lock and able to indicate if the lock is locked or unlocked.

### BRIEF DESCRIPTION OF THE DRAWINGS

The present invention will be understood and appreciated more fully from the following detailed description taken in conjunction with the drawing in which:

FIG. 1 is a simplified pictorial illustration of a lock status indicator, constructed and operative in accordance with an embodiment of the present invention.

### DETAILED DESCRIPTION OF THE PREFERRED EMBODIMENT

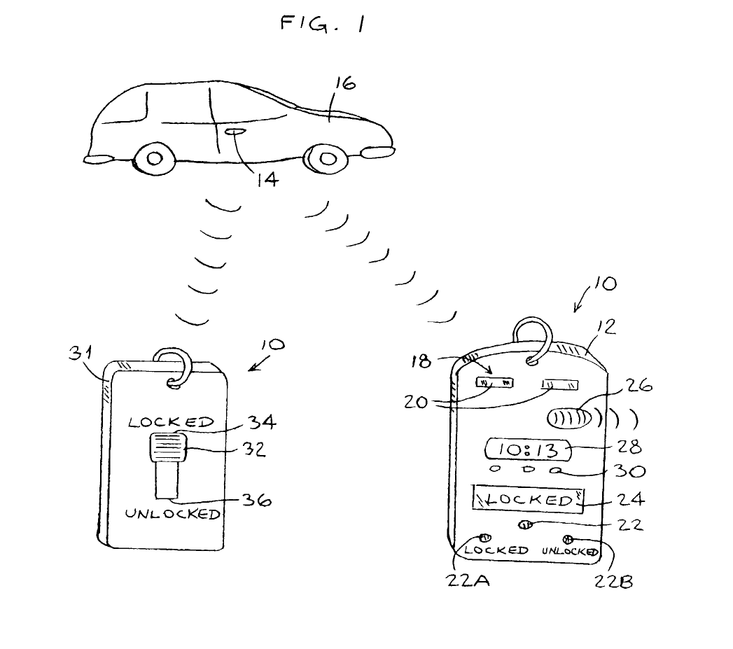

Reference is now made to FIG. 1, which illustrates a lock status indicator 10, constructed and operative in accordance with an embodiment of the present invention.

Lock status indicator 10 may be mounted in or on a key ring fob 12. Lock status indicator 10 may be used in conjunction with a lock 14, such as but not limited to, a door lock of a vehicle 16. Key ring fob 12 may also comprise a remote control 18 that controls locking and unlocking of lock 14. For example, remote control 18 may comprise push buttons 20 for remotely locking and unlocking lock 14, as is well known in the art.

Lock status indicator 10 may comprise a visual or audible indicator that indicates if lock 14 is locked or unlocked. Lock status indicator 10 may accordingly indicate if the last action performed on lock 14 was a locking or an unlocking action. For example, lock status indicator 10 may comprise, without limitation, a light 22 (e.g., LCD or LED) that illuminates in a code to indicate whether lock 14 is locked or unlocked. For example, if light 22 is illuminated steadily, lock 14 is locked; if light 22 flashes, lock 14 is unlocked. As another example, if light 22 is illuminated red, lock 14 is locked; if light 22 is green, lock 14 is unlocked. As still another example, lock status indicator 10 may comprise, without limitation, one light 22A that illuminates if lock 14 is locked and another light 22B that illuminates if lock 14 is unlocked. A combination of different lights, flashing illumination, steady illumination and different colors may also be used. As still another example, lock status indicator 10 may comprise, without limitation, an alphanumeric display 24, which may display the word “LOCKED” if lock 14 is locked and the word “UNLOCKED” if lock 14 is unlocked. As another example, alphanumeric display 24 may display a picture or icon of a locked lock if lock 14 is locked and a picture or icon of an unlocked lock if lock 14 is unlocked.

As yet another example, lock status indicator 10 may comprise an audible indicator 26, such as but not limited to, a beeper that beeps different sounds depending on whether lock 14 is locked or unlocked. It is appreciated that these are just some examples of many other possibilities of lock status indicator 10 indicating whether lock 14 is locked or unlocked.

In accordance with an embodiment of the present invention, lock status indicator 10 may comprise a time indicating device 28 that indicates when the last action was performed on lock 14. For example, when one of push buttons 20 has been used to lock the lock 14, lock status indicator 10 indicates that lock 14 is in a locked status, and time indicating device 28 indicates that the locked status was reached at 10:13. Time indicating device 28 may further comprise push buttons 30 for activating different operational modes, such that time indicating device 28 may be used to indicate the current time (as a regular watch or clock), or may be used as an alarm clock, a timer and/or an elapsed time display.

In accordance with another embodiment of the present invention, the remote control used to lock or unlock the lock 14 may itself comprise the lock status indicator. For example, a remote control 31 may comprise, without limitation, a two-state switch 32 that is movable between a first position 34 that generates a signal to lock the lock 14 and a second position 36 that generates a signal to unlock the lock 14. The two-state switch 32 may comprise, without limitation, a sliding push switch. The first position 34 may have character markings that indicate a locked status of the lock 14, such as but not limited to, the word “LOCKED” or a picture or icon of a locked lock. The second position 36 may have character markings that indicate an unlocked status of the lock 14, such as but not limited to, the word “UNLOCKED” or a picture or icon of an unlocked lock. The two-state switch 32 normally remains at either of the first or second positions until moved to the other position. Thus, the position of two-state switch 32 may serve as an indication of the locked status of lock 14. It is noted that the features of remote control 31 may be incorporated in the key ring fob 12. It is further noted that first position 34 and second position 36 are preferably not continuous transmission positions. In other words, for example when locking the lock 14, two-state switch 32 may be moved to the first position 34, which transmits the signal to lock the lock 14, and then the two-state switch 32 may move slightly backwards so as not to continuously transmit the locking signal, but still remains sufficiently in the first position 32 to indicate that the lock 14 is “LOCKED”. The similar situation holds true for the second position 36.

In accordance with an embodiment of the present invention, lock status indicator 10 may also be used to indicate status of other systems related to the lock 14, such as but not limited to, showing status of an alarm system (e.g., is the alarm system working, reset, etc.).

It will be appreciated by person skilled in the art that the present invention is not limited by what has been particularly shown and described herein above. Rather the scope of the present invention is defined only by the claims that follow:

What is claimed is:

1. Apparatus comprising:
a key ring fob comprising a lock status indicator able to indicate if a lock is locked or unlocked.

2. The apparatus according to claim 1, wherein said lock status indicator is able to indicate if the last action performed on the lock was a locking or an unlocking action.

3. The apparatus according to claim 1, wherein said lock status indicator comprises a time indicating device able to indicate when the last action performed on the lock was performed.

4. The apparatus according to claim 1, wherein said lock status indicator comprises a visual indicator.

5. The apparatus according to claim 4, wherein said visual indicator comprises at least one of a light with an illumination code and an alphanumeric display.

6. The apparatus according to claim 1, wherein said lock status indicator comprises an audible indicator.

7. The apparatus according to claim 1, wherein said key ring fob further comprises a remote control to lock or unlock a lock.

8. The apparatus according to claim 1, wherein said lock status indicator comprises a remote control to lock or unlock a lock, said remote control comprising a two-state switch that is movable between a first position that generates a signal to lock the lock and a second position that generates a signal to unlock the lock, said first position comprising character markings that indicate a locked status of the lock and said second position comprising character markings that indicate an unlocked status of the lock.

9. The apparatus according to claim 3, wherein said time indicating device comprises at least one of a time indication of the current time, an alarm clock, a timer and an elapsed time display.

10. A method for indicating lock status, comprising:
providing a lock status indicator, able to indicate if a lock is locked or unlocked, on a key ring fob.

11. The method according to claim 10, further comprising using said lock status indicator to indicate if the last action performed on the lock was a locking or an unlocking action.

12. The method according to claim 10, further comprising using said lock status indicator to indicate when the last action performed on the lock was performed.

13. A system comprising:
a lock; and
a key ring fob comprising a lock status indicator communicable with said lock and able to indicate if said lock is locked or unlocked.

14. The system according to claim 13, wherein said lock status indicator is able to indicate if the last action performed on said lock was a locking or an unlocking action.

15. The system according to claim 13, wherein said lock status indicator comprises a time indicating device able to indicate when the last action performed on said lock was performed.
